(19) United States
(12) Patent Application Publication
(10) Pub. No.: US 2020/0398713 A1
(43) Pub. Date: Dec. 24, 2020

(54) MOTOR VEHICLE SEAT AND METHOD FOR ABSORBING ENERGY IN A MOTOR VEHICLE SEAT

(71) Applicant: FAURECIA AUTOSITZE GMBH, Stadthagen (DE)

(72) Inventor: Meinhard Behrens, Wiedensahl (DE)

(73) Assignee: FAURECIA AUTOSITZE GMBH, Stadthagen (DE)

(21) Appl. No.: 16/446,249

(22) Filed: Jun. 19, 2019

(51) Int. Cl. B60N 2/427; B60N 2/06; B60N 2/20; B60N 2/433

(52) U.S. Cl. CPC B60N 2/427; B60N 2/42709; B60N 2/433; B60N 2/06; B60N 2/20; B60N 2/42772

(57) ABSTRACT

A motor vehicle seat includes an adjusting device for adjusting a first seat component. The adjusting device is configured to adjust the first seat component of the motor vehicle seat into a first adjustment region and a second adjustment region. The motor vehicle seat further includes an energy absorption device, which absorbs energy when a threshold load is exceeded. The energy absorbed by the energy absorption device and/or the threshold load when the first component is in the first adjustment region is different from the energy absorbed by the energy absorption device and/or the threshold load when the first component is in the second adjustment region.

### BACKGROUND OF THE INVENTION

The present invention relates to a motor vehicle seat and to a method for absorbing energy in a motor vehicle seat.

The following discussion of related art is provided to assist the reader in understanding the advantages of the invention, and is not to be construed as an admission that this related art is prior art to this invention.

The inclination of a backrest of a motor vehicle seat can be adjusted by an angle with respect to the vertical of such a magnitude that a rest position may be set. In this rest position, the angle of inclination is so large that the risk of injury to an occupant in the event of a rear-end collision is significantly increased in comparison with an upright position of the backrest. There is the risk that the occupant slides through the belt strap of a seat belt and comes into contact with components in the front region of the vehicle interior, e.g. with the steering wheel, dashboard, windscreen. The injuries may be significant, as the negative acceleration in the event of a collision can be very high. Although airbag systems can reduce the risk of injury, they are designed for an occupant sitting upright and they require a lot of maintenance. This problem can arise in particular for the passenger, who can adjust the passenger seat into a comfortable position irrespective of the requirements of a seat position of the vehicle driver. However, a seat position of this kind can be considered for the vehicle driver, too, if the motor vehicle is able to move autonomously through traffic.

It would therefore be desirable and advantageous to provide an improved energy absorption device which obviate prior art shortcomings and which can be installed and serviced reliably and cost-effectively.

### SUMMARY OF THE INVENTION

According to one aspect of the present invention, a motor vehicle seat which includes a first adjusting device configured to adjust a first seat component in a first adjustment region and a second adjustment region, and an energy absorption device configured to absorb energy when a threshold load is exceeded, wherein the energy absorbed by the energy absorption device and/or the threshold load when the first seat component assumes the first adjustment region is different from the energy absorbed by the energy absorption device and/or the threshold load when the first seat component assumes the second adjustment region.

A motor vehicle seat according to the invention includes an adjusting device by which the first seat component of the motor vehicle seat can be adjusted into first and second adjustment positions. The motor vehicle seat according to the invention advantageously includes an energy absorption device to absorb energy when a threshold load is exceeded. The energy absorbed by the energy absorption device and/or the threshold load to be exceeded have different values when the first seat component is positioned in the first or the second adjustment position.

The first seat component can be e.g. a longitudinal seat adjustment of the motor vehicle seat. A motor vehicle seat according to the invention significantly reduces a risk of injury to an occupant of the motor vehicle seat in the event of a head-on collision. The first adjustment position of the first seat component typically refers to a position in which the motor vehicle seat is adjusted as far forward as possible in the vehicle longitudinal axis, whereas the second adjustment position refers to a position that is as far backward as possible. It has been found that when the backrest is at larger angles of inclination, an occupant of the motor vehicle seat is unconsciously adjusted into a backward position. In a substantially horizontal rest position of the backrest of the motor vehicle seat, the kinetic energy generated by a sharp negative acceleration in the event of e.g. a head-on collision of the vehicle is compensated for and reduced by the energy absorption device of the motor vehicle seat as soon as a previously set threshold load is exceeded. This set threshold load is defined by the critical compensation force of the human spine. In the rest position of the backrest, the restraining force of a belt system is significantly reduced in comparison with an upright position of the backrest, because the occupant of the motor vehicle seat can slide forward under the belt strap. The absorbed energy of the energy absorption device therefore has different values depending on the position of the longitudinal seat adjustment. Injury to the occupant due to contact with components in the front region of the vehicle interior is thus reduced.

The energy absorbed by the energy absorption device can have a specific value when the first seat component is positioned in the first adjustment region. This value of the absorbed energy is greater when the first seat component is positioned in the second adjustment region. In a rest position of the backrest of the motor vehicle seat, the kinetic energy produced by the sharp negative acceleration in the event of e.g. a head-on collision of the vehicle is compensated for and reduced by the energy absorption device of the motor vehicle seat. An occupant of the motor vehicle seat can slide under the belt strap of a belt system when the backrest is positioned in the rest position. In a substantially vertical position of the backrest in the first adjustment region of the first seat component, the kinetic energy is absorbed by the belt system, not or only to a small extent by the energy absorption device. The absorbed energy of the energy absorption device is therefore greater when the first seat component is positioned in the second adjustment position.

According to another advantageous feature of the present invention, the threshold load to be exceeded can have, for activating the energy absorption device, a specific value when the first seat component is positioned in the first adjustment region. This value of the threshold load to be exceeded is greater when the first seat component is positioned in the second adjustment region. In a rest position of the backrest of the motor vehicle seat, the kinetic energy produced by a sharp negative acceleration in the event of e.g. a head-on collision of the vehicle is compensated for and reduced by the energy absorption device of the motor vehicle seat. An occupant of the motor vehicle seat can slide under the belt strap of a belt system when the backrest is positioned in the rest position. In a substantially vertical position of the backrest in the first adjustment region of the first seat component, the kinetic energy is absorbed by the belt system, not and/or only to a small extent by the energy absorption device. The absorbed energy of the energy absorption device is therefore greater when the first seat component is positioned in the second adjustment position. The value of the threshold load that is exceeded in order to activate the energy absorption device is therefore higher in the second adjustment region of the first seat component.

According to another advantageous feature of the present invention, the first seat component undergoes a movement during the absorption of energy. The energy absorption of the energy absorption device can be a movement of the first seat component which is e.g. a longitudinal seat adjustment of the motor vehicle seat. Energy absorption is then carried out by a forward movement of the motor vehicle seat in the rails of the longitudinal seat adjustment.

According to another advantageous feature of the present invention, the movement that is carried out by the first seat component during the energy absorption can have a lower value when the first seat component is positioned in the first adjustment position than when the first seat component is positioned in the second adjustment position. In the rest position of the backrest, the restraining force of a belt system in the event of a head-on collision is limited, because the occupant can slide through the belt strap. Energy absorption is then realized by a forward movement of the motor vehicle seat, e.g. in the rails of the longitudinal seat adjustment. This movement is greater when the longitudinal seat adjustment is adjusted as far backwards as possible compared to a situation when the longitudinal seat adjustment assumes a position as far forward as possible. An occupant is restrained by the restraining force of the energy absorption device in the rest position of the backrest, reducing the risk of injury.

According to another advantageous feature of the present invention, the energy absorption device can be activated only when the first seat component is positioned in the second adjustment region. Whereas, in the first adjustment region of the first seat component, a belt system restrains the occupant and compensates for the kinetic energy in the event of a head-on collision, the energy is absorbed in the second adjustment region by the energy absorption device, e.g. by a forward movement of the longitudinal seat adjustment. It is therefore not necessary to activate the energy absorption device in the first adjustment region of the first seat component.

According to another advantageous feature of the present invention, the energy absorption device can be embodied as a deformation element, a pyro element or as a gas generator. A deformation element can be a mechanically deformable metal, e.g. a spring or tab. A pyro element and a gas generator can generate a force which opposes the force produced in the event of a head-on collision.

According to another advantageous feature of the present invention, the first and the second adjustment regions of the first seat component do not overlap. The two adjustment regions of the first seat component are therefore clearly separate from one another. In the first adjustment region of the first seat component, the energy absorption is realized by a belt system, while in the second adjustment region, the energy absorption is realized by the energy absorption device.

According to another advantageous feature of the present invention, the first adjusting device can be a device by means of which the motor vehicle seat can be adjusted in the longitudinal direction. The energy absorption by the energy absorption device is realized when the driver's seat is positioned in the second adjustment region by the longitudinal seat adjustment.

According to another advantageous feature of the present invention, the second adjustment region of the first seat component can be arranged on a side that is remote from the front of the vehicle. Energy is absorbed by the energy absorption device when the driver's seat is positioned backwards in the second adjustment region by means of the longitudinal seat adjustment.

According to another advantageous feature of the present invention, the first adjusting device can be a device by means of which the angle of inclination of the backrest can be adjusted. In the event of a head-on collision, the energy absorption device acts on the backrest to move the backrest into an upright vertical position. The occupant is restrained by the belt system; the risk of sliding under the belt strap is slight.

According to another advantageous feature of the present invention, the second adjustment region can be in a range of a large angle of inclination of the backrest. In the range of a large angle of inclination of the backrest, there is a significant risk in the event of a head-on collision that an occupant slides through the belt strap and is not restrained by the belt system. Contact with components in the front vehicle interior increases the risk of injury. In the event of a head-on collision, the energy absorption device adjusts the backrest into an upright position and the occupant is restrained by the belt system.

According to another advantageous feature of the present invention, the second adjustment region can be in a range of an angle of inclination of the backrest of greater than 30°, preferably greater than 40° and currently particularly preferably greater than 50°, measured from the vertical position of the backrest. It has been found that when the backrest is at larger angles of inclination, an occupant of the motor vehicle seat is unconsciously adjusted into a backward position. In the range of a large angle of inclination of the backrest, there is a significant risk in the event of a head-on collision that an occupant slides through the belt strap and is not restrained by the belt system. Contact with components in the front vehicle interior increases the risk of injury. In the event of a head-on collision, the energy absorption device adjusts the backrest into an upright position and the occupant is restrained by the belt system.

According to another advantageous feature of the present invention, the energy absorption device can be arranged on a second seat component. The first seat component can be e.g. a longitudinal adjustment of the driver's seat and the second seat component can be an adjustment of the angle of inclination of the backrest. In the event of a head-on collision, the energy absorption device acts on the backrest to move the backrest into an upright vertical position. The occupant is restrained by the belt system; the risk of sliding under the belt strap is slight.

According to another aspect of the present invention, a method for absorbing energy in a motor vehicle seat includes determining an adjustment position of a seat component of the motor vehicle seat, detecting an overload situation, and absorbing energy by an energy absorption device.

A motor vehicle seat according to the invention includes an adjusting device which adjusts a first seat component into a first and second adjustment region, and an energy absorption device. A method for absorbing energy of a motor vehicle seat in accordance with the present invention includes three method steps. In the first method step, the adjustment position of the first seat component is detected. In the second method step, an overload situation is detected. In the third method step, the energy absorption device absorbs the energy.

When the first seat component is a longitudinal seat adjustment, it is established in the first method step whether the motor vehicle seat is adjusted in the first or second adjustment position, i.e. whether the motor vehicle seat is in a front or rear position. When the first seat component is a device for adjusting the angle of inclination of the backrest, the angle of inclination of the backrest is detected. In the second method step, it is detected whether the threshold load has been exceeded for the energy absorption device to be activated, i.e. whether a sharp negative acceleration acts on the motor vehicle seat such that there is a risk of injury to an occupant. In the third method step, the energy of the head-on collision is compensated for by the energy absorption device such that the risk of injury to an occupant is reduced.

According to another advantageous feature of the present invention, the detected adjustment position can be associated with an adjustment region. In the event of a head-on collision, the energy absorption device is activated only when the adjustment position is in the second adjustment region. When the first seat component is a longitudinal seat adjustment, it is detected whether the driver's seat is adjusted into the rear region. When the first seat component is a device for adjusting the angle of inclination of the backrest, it is established whether the angle of inclination of the backrest, measured from the vertical position, is in the second adjustment region.

According to another advantageous feature of the present invention, the energy absorption device can be activated when the first seat component is positioned in the second adjustment region. When, in the event of a head-on collision, the threshold load is exceeded and the drives seat is positioned in the rear region or the angle of inclination of the backrest is so large that there is the risk of the occupant sliding under the belt strap of a belt system, the energy absorption device is activated. The kinetic energy in the event of a head-on collision is compensated for and the risk of injury to an occupant is reduced.

According to another advantageous feature of the present invention, the first adjusting device can be a device by means of which the motor vehicle seat can be adjusted in the longitudinal direction. The energy absorption by the energy absorption device is then realized when the driver's seat is positioned in the second adjustment region by the longitudinal seat adjustment.

According to another advantageous feature of the present invention, the second adjustment region of the first seat component can be on a side that is remote from the front of the vehicle. Energy is absorbed by the energy absorption device when the driver's seat is positioned backwards in the second adjustment region by means of the longitudinal seat adjustment.

According to another advantageous feature of the present invention, a seat component executes a movement during the absorption of energy. The energy absorption of the energy absorption device can be a movement of the first seat component. Energy absorption is then carried out by a forward movement of the motor vehicle seat in the rails of the longitudinal seat adjustment. By means of e.g. a deformation element, pyro element or gas generator, a force can be generated which opposes the force produced in the event of a head-on collision.

According to another advantageous feature of the present invention, the adjustment position of a first seat component can be determined. The second seat component executes a movement in order to absorb energy. The first seat component can be e.g. a longitudinal seat adjustment of the driver's seat and the second seat component can be a device for adjusting the angle of inclination of the backrest. In the event of a head-on collision, the energy absorption device acts on the backrest to move the backrest into an upright vertical position. The occupant is restrained by the belt system so that the risk of sliding under the belt strap is slight.

According to another advantageous feature of the present invention, the second seat component can be a backrest. The movement for absorbing energy is realized by the backrest as it is moved upright into a position having a smaller angle of inclination with respect to the vertical. In the event of a head-on collision, the energy absorption device acts on the backrest to move the backrest into an upright vertical position. The occupant is restrained by the belt system so that the risk of sliding under the belt strap is slight.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1a is a schematic illustration of a conventional motor vehicle seat with a seat belt and a backrest in upright position;

FIG. 1b is a schematic illustration of the conventional motor vehicle seat of FIG. 1, depicting the backrest in a rest position;

FIG. 2a is a schematic illustration of a motor vehicle seat according to the present invention, depicting the motor vehicle seat in a front adjustment region, with an energy absorption device in a longitudinal seat adjustment;

FIG. 2b is a schematic illustration of the motor vehicle seat of FIG. 2a in a rear adjustment region;

FIG. 3a is a schematic illustration of a motor vehicle seat according to the present invention, depicting the motor vehicle seat in in a front adjustment region, with an energy absorption device in a backrest;

FIG. 3b is a schematic illustration of the motor vehicle seat of FIG. 3a in a rear adjustment region;

FIG. 4a is a schematic illustration of a motor vehicle seat according to the present invention in a front adjustment region, depicting a mode of operation of the motor vehicle seat, with the energy absorption device in a longitudinal seat adjustment;

FIG. 4b is a schematic illustration of the motor vehicle seat of FIG. 4a in a rear adjustment region;

FIG. 5a is a schematic illustration of a motor vehicle seat according to the present invention in a front adjustment region, depicting a mode of operation of the motor vehicle seat, with the energy absorption device in a backrest; and

FIG. 5b is a schematic illustration of the motor vehicle seat of FIG. 5a in a rear adjustment region.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments may be illustrated by graphic symbols, phantom lines, diagrammatic representations and fragmentary views. In certain instances, details which are not necessary for an understanding of the present invention or which render other details difficult to perceive may have been omitted.

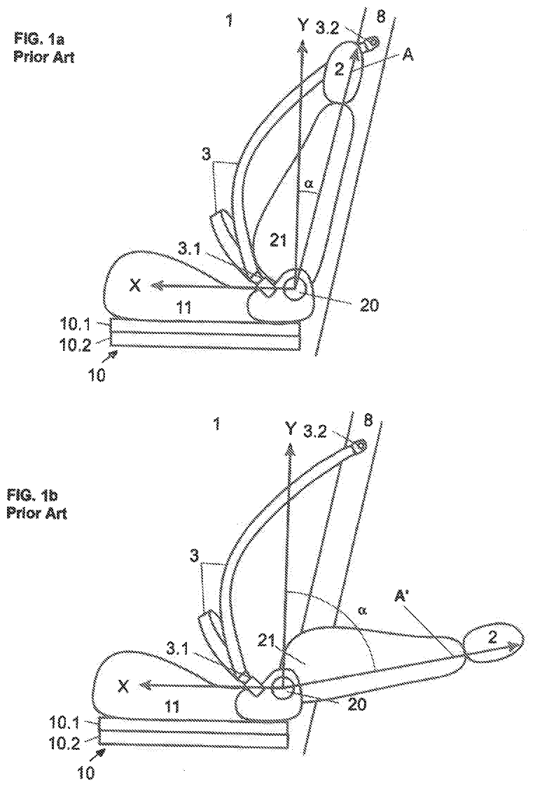

Turning now to the drawing, and in particular to FIG. 1a, there is shown a schematic illustration of a conventional motor vehicle seat 1 with a belt system which reduces the risk of injury in the event of a collision by restraining an occupant and preventing the occupant from coming into contact with components in the front region of the vehicle interior, e.g. the steering wheel, dashboard, windscreen or another motor vehicle seat 1. The motor vehicle seat 1 includes a headrest 2, a seat rest as a first seat component 11, and a second seat component 21 is formed by the backrest. The angle of inclination α of the second seat component 21 can be adjusted from the vertical orientation Y by a device 20. The motor vehicle seat 1 is adjusted in a longitudinal direction X by a longitudinal seat adjustment 10 having an upper rail 10.1 and a lower rail 10.2. A seat belt 3 is secured to the seat rest 11 and at attachment point 3.2 to the B pillar 8 and fastened by a buckle 3.1. In its upright position, as shown in FIG. 1a and indicated by arrow A, the second seat component 21 extends at a small angle α of inclination and an occupant is restrained by the seat belt 3 in the event of a collision. At a large angle of inclination α of the second seat component 21, as shown in FIG. 1b, the second seat component 21 is adjusted into a rest position, at most as far back as to assume a substantially horizontal position, as indicated by arrow A′. In this rest position, the restraining force of a belt system is significantly reduced in comparison with an upright position of the second seat component 21, because the occupant of the motor vehicle seat 1 can slide forward under the belt strap. The risk of injury to an occupant in the event of a collision is increased.

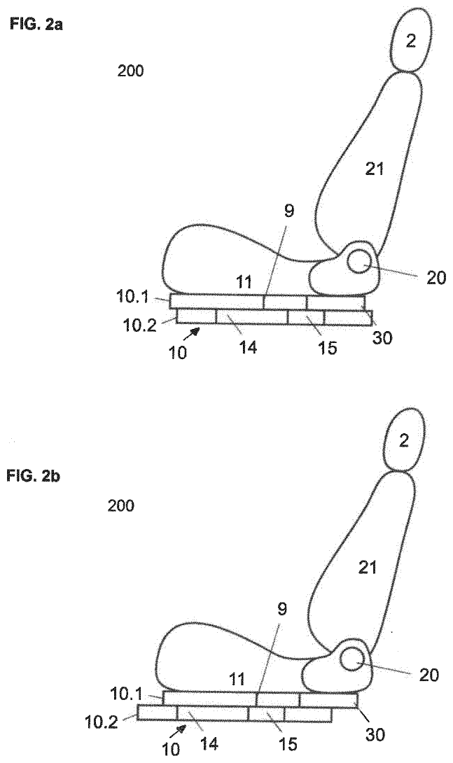

Referring now to FIG. 2a, there is shown a schematic illustration of a motor vehicle seat according to the present invention, generally designated by reference numeral 200. In the following description, parts corresponding with those in FIGS. 1a and 1b will be identified, where appropriate for the understanding of the invention, by corresponding reference numerals. The motor vehicle seat 200 includes a headrest 2, a seat rest as a first seat component 11, and a backrest as a second seat component 21. The angle of inclination of the second seat component 21 can be adjusted from a vertical orientation by a mechanical or electromechanical device 20. The motor vehicle seat 200 is adjusted, mechanically or electromechanically, in a longitudinal direction into a first adjustment position and a second adjustment position by a longitudinal seat adjustment 10 which includes an upper rail 10.1 and a lower rail 10.2. A sensor 9 detects a position of the first seat component 11.

An energy absorption device 30 is incorporated or integrated in the longitudinal seat adjustment 10. FIG. 2a shows the first seat component 11 as being restricted in a first adjustment region 14 to a front adjustment region of the longitudinal seat adjustment means. It has been found that when the second seat component 21 is at a larger angle of inclination, an occupant of the motor vehicle seat 200 is unconsciously adjusted into a backward position; when the second seat component is at a smaller angle of inclination, and an occupant typically adjusts the first seat component 11 into an upright, substantially vertical position, in order to e.g. reach a steering wheel. In the front adjustment region 14 of the first seat component 11 and at a small angle of inclination of the second seat component 21, the occupant is restrained by the seat belt in the event of a collision. The energy absorption device 30 is not activated. The second adjustment region 15 of the first seat component 11, as shown in FIG. 2b, is restricted to the rear adjustment region of the longitudinal seat adjustment 10. In the second adjustment region 15 and at a large angle of inclination of the second seat component 21, the restraining force is compensated only to a small extent by the seat belt in the event of a head-on collision, because the occupant can slide through the belt strap. The energy absorption device 30 is activated as soon as a previously set threshold load is exceeded in response to a high negative acceleration in the event of e.g. a head-on collision. The first adjustment region 14 and second adjustment region 15 of the first seat component 11 do not overlap. In the first adjustment region 14 of the first seat component 11, the energy absorption is realized by a belt system, and: in the second adjustment region 15, energy absorption is realized by the energy absorption device 30.

In order to activate the energy absorption device 30, it is first established whether the motor vehicle seat 200 is adjusted in the first adjustment region 14 or second adjustment region 15, i.e. whether the motor vehicle seat 200 is in a front or rear position. It is then detected whether the threshold load has been exceeded for the energy absorption device 30 to be activated, i.e. whether a negative acceleration acts on the motor vehicle seat 200 such that there is a risk of injury to an occupant. Finally, the energy of the head-on collision is compensated by the energy absorption device 30 in the longitudinal seat adjustment such that the risk of injury to an occupant is reduced when the first seat component 11 is positioned in the second adjustment region 15.

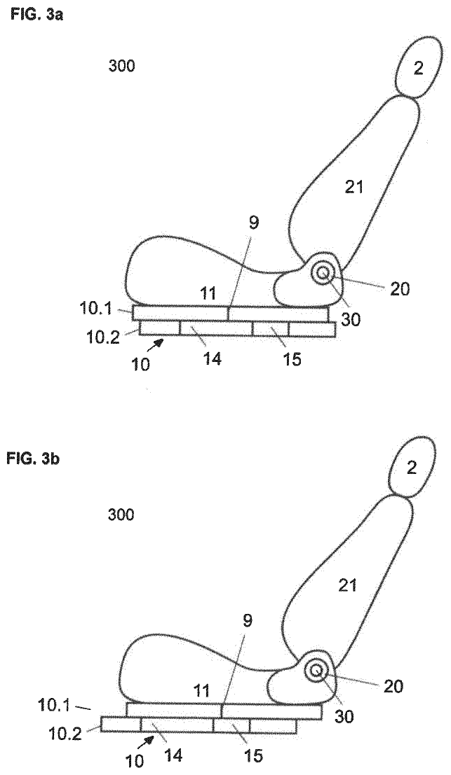

FIG. 3a shows a schematic illustration of a motor vehicle seat according to the present invention, generally designated by reference numeral 300. Parts corresponding with those in FIGS. 2a and 2b are denoted by identical reference numerals and not explained again. The motor vehicle seat 300 includes a headrest 2, a seat rest as the first seat component 11, and a backrest as the second seat component 21. The angle of inclination of the second seat component 21 can be adjusted from the vertical by a mechanical or electromechanical device 20. The motor vehicle seat 300 is adjusted, mechanically or electromechanically, in a longitudinal direction into a first adjustment position and a second adjustment position by a longitudinal seat adjustment 10 which includes an upper rail 10.1 and a lower rail 10.2. A sensor 9 detects a position of the first seat component 11.

In this embodiment, provision is made for an energy absorption device 30 which is integrated in the second seat component or backrest 21 and acts thereon. In the first adjustment region 14, as shown in FIG. 3a, the first seat component 11 is restricted to the front adjustment region of the longitudinal seat adjustment 10. In the front adjustment region 14 of the first seat component 11 and at a small angle of inclination of the second seat component 21, the occupant is restrained by the seat belt in the event of a collision and the energy absorption device 30 is not activated. The second adjustment region 15 of the first seat component 11, as shown in FIG. 3b, is restricted to the rear adjustment region of the longitudinal seat adjustment 10. In the second adjustment region 15 and at a large angle of inclination of the second seat component 21, the restraining force is compensated only to a small extent by the seat belt in the event of a head-on collision, because the occupant can slide through the belt strap. The energy absorption device 30 is activated as soon as a previously set threshold load has been reached or exceeded. The energy absorption device 30 is in particular activated when the angle of inclination of the backrest 21 is greater than 30°, preferably greater than 40° and particularly preferably greater than 50°. When the backrest 21 is reclined at a large angle of inclination, the risk increases that an occupant slides under the belt strap.

In order to activate the energy absorption device 30, it is first established whether the motor vehicle seat 300 is adjusted in the first adjustment region 14 or second adjustment region 15, i.e. whether the motor vehicle seat 300 assumes a front position or a rear position. It is then detected whether the threshold load has been exceeded for the energy absorption device 30 to be activated, i.e. whether a sharp negative acceleration acts on the motor vehicle seat 1 such that there is a risk of injury to an occupant. Finally, the energy of the head-on collision is compensated by the energy absorption device 30 in the backrest 21 such that the risk of injury to an occupant is reduced when the first seat component 11 is positioned in the second adjustment region 15.

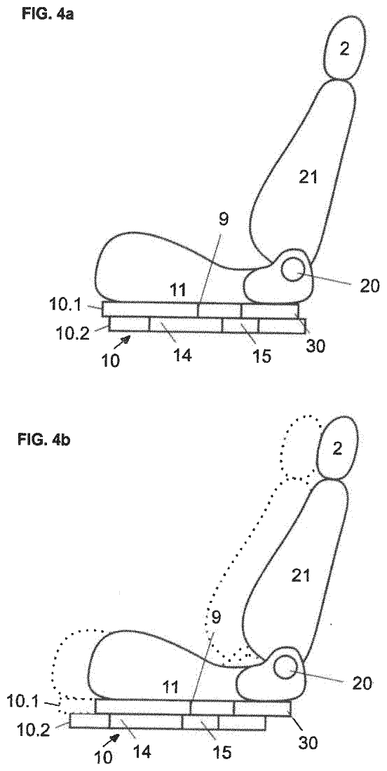

The mode of operation of the energy absorption device 30, which is integrated in the longitudinal seat adjustment, is shown in FIGS. 4a and 4b. The motor vehicle seat 200, 300 includes headrest 2, a seat rest as the first seat component 11, and a backrest as the second seat component 21. The angle of inclination of the second seat component 21 can be adjusted from the vertical by a mechanical or electromechanical device 20. The motor vehicle seat 200, 300 is adjusted, mechanically or electromechanically, in the longitudinal direction into first and second adjustment positions by the longitudinal seat adjustment 10. Sensor 9 detects the position of the first seat component 11. The energy absorption device 30 is integrated here in the longitudinal seat adjustment 10. In the first adjustment region 14 (FIG. 4a), the first seat component 11 is restricted to the front adjustment region of the longitudinal seat adjustment 10. In the event of a collision, the energy absorption device 30 is not activated. The second adjustment region 15 (FIG. 4b) of the first seat component 11 is restricted to the rear adjustment region 15 of the longitudinal seat adjustment 10, with the dotted line indicating the front adjustment region 14 to depict the adjustment of the motor vehicle seat 200, 300. The energy absorption device 30 is activated as soon as a previously set threshold load is exceeded by high negative acceleration in the event of e.g. a head-on collision. The energy absorption device 30 leads to such a movement that the motor vehicle seat 200, 300 slides forward in the rails of the longitudinal seat adjustment 10.

In order to activate the energy absorption device 30, it is first established whether the motor vehicle seat 200, 300 is adjusted in the first adjustment region 14 or second adjustment region 15, i.e. whether the motor vehicle seat 1 is in a front position or rear position. It is then detected whether the threshold load has been exceeded for the energy absorption device 30 to be activated, i.e. whether a sharp negative acceleration acts on the motor vehicle seat 1 such that there is a risk of injury to an occupant. Finally, the energy of the head-on collision is compensated by the energy absorption device 30 in the longitudinal seat adjustment 10 such that the risk of injury to an occupant is reduced when the first seat component 11 is positioned in the second adjustment region 15. The energy absorption device 30 can be e.g. a deformation element, e.g. a spiral spring, which is mounted in the longitudinal direction of the motor vehicle seat 200, 300. Ridges in the longitudinal seat adjustment 10 are also possible, which ridges are deformed in the event of a collision and compensate the kinetic energy. The provision of a pyro element or a gas generator to generate a force that opposes the force produced in the event of a head-on collision and decelerates the motor vehicle seat 200, 300 is also conceivable.

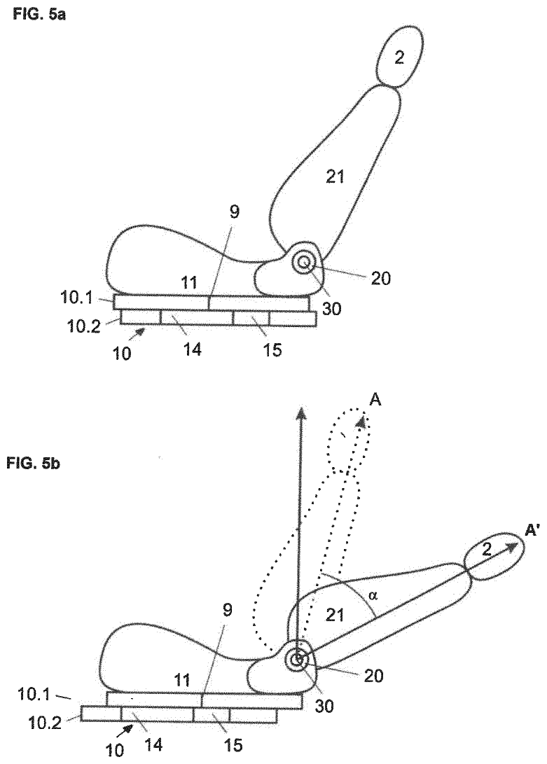

The mode of operation of the energy absorption device 30, when integrated in the backrest 21, is shown in FIGS. 5a and 5b. The motor vehicle seat 200, 300 includes headrest 2, a seat rest as the first seat component 11, and a backrest as the second seat component 21. The angle of inclination α of the second seat component 21 can be adjusted from the vertical by a mechanical or electromechanical device 20. The motor vehicle seat 200, 300 is adjusted, mechanically or electromechanically, in the longitudinal direction into first and second adjustment positions by longitudinal seat adjustment 10. Sensor 9 detects the position of the first seat component 11. The energy absorption device 30 is integrated in the backrest 21. In the first adjustment region 14, as shown in FIG. 5a and by way of dotted line in FIG. 5b, the first seat component 11 is restricted to the front adjustment region 14 of the longitudinal seat adjustment 10. The energy absorption device 30 is not activated in the event of a collision, and an occupant is restrained by the seat belt. The second adjustment region (FIG. 5b) of the first seat component 11 is restricted to the rear adjustment region 15 of the longitudinal seat adjustment 10. The energy absorption device 30 is activated as soon as a previously set threshold load has been reached or exceeded. In the event of a head-on collision, the energy absorption device 30 acts on the backrest 21 to move the backrest 21 from a reclined position, as indicated by arrow A′ into an upright vertical position, as indicated by arrow A. The occupant is restrained by the belt system.

In order to activate the energy absorption device 30, it is first established whether the motor vehicle seat 200, 300 is adjusted in the first adjustment region 12 or second adjustment region 13, i.e. whether the motor vehicle seat 200, 300 assumes a front or rear position. It is then detected whether the threshold load has been exceeded for the energy absorption device 30 to be activated, i.e. whether a sharp negative acceleration acts on the motor vehicle seat 1 such that there is a risk of injury to an occupant. Finally, the energy of the head-on collision is compensated for by the energy absorption device 30 in the backrest 21 such that the backrest 21 is adjusted at a smaller pivot angle with respect to the vertical.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A motor vehicle seat, comprising:
a first adjusting device configured to adjust a first seat component in a first adjustment region and a second adjustment region; and
an energy absorption device configured to absorb energy when a threshold load is exceeded, wherein the energy absorbed by the energy absorption device and/or the threshold load when the first seat component assumes the first adjustment region is different from the energy absorbed by the energy absorption device and/or the threshold load when the first seat component assumes the second adjustment region.

2. The motor vehicle seat of claim 1, wherein the energy absorbed by the energy absorption device when the first seat component is positioned in the first adjustment region is smaller than the energy absorbed by the energy absorption device when the first seat component is positioned in the second adjustment region.

3. The motor vehicle seat of claim 1, wherein the threshold load, when the first seat component is positioned in the first adjustment region, is greater than the threshold load when the first seat component is positioned in the second adjustment region.

4. The motor vehicle seat of claim 1, wherein the energy absorption device is activated only when the first seat component assumes the second adjustment region.

5. The motor vehicle seat of claim 1, wherein the energy absorption device is configured as a deformation element, pyro element, resistance element or gas generator.

6. The motor vehicle seat of claim 1, wherein the first adjustment region and the second adjustment region do not overlap.

7. The motor vehicle seat of claim 1, wherein the first adjusting device is a longitudinal seat adjustment, with the second adjustment region being arranged on a side of the longitudinal seat adjustment which side is remote from a vehicle front.

8. The motor vehicle seat of claim 1, wherein the first adjusting device is a backrest inclination adjustment.

9. The motor vehicle seat of claim 1, wherein the second adjustment region is arranged in a range of a large inclination of a backrest.

10. The motor vehicle seat of claim 9, wherein the second adjustment region is in a range of greater than 30° inclination from a perpendicular position of the backrest.

11. The motor vehicle seat of claim 9, wherein the second adjustment region is in a range of greater than 40° inclination from a perpendicular position of the backrest.

12. The motor vehicle seat of claim 9, wherein the second adjustment region is in a range of greater than 50° inclination from a perpendicular position of the backrest.

13. The motor vehicle seat of claim 1, further comprising a second adjusting device configured to adjust a second seat component, said energy absorption device being arranged on the second adjusting device.

14. A method for absorbing energy in a motor vehicle seat, comprising:
determining an adjustment position of a seat component of the motor vehicle seat;
detecting an overload situation; and
absorbing energy by an energy absorption device.

15. The method of claim 14, further comprising associating the determined adjustment position with one of a first adjustment region and a second adjustment region of an adjusting device of the motor vehicle seat.

16. The method of claim 15, further comprising activating the energy absorption device when the seat component is in the second adjustment region.

17. The method of claim 15, further comprising activating the energy absorption device when the seat component is in the second adjustment region.

18. The method of claim 14, wherein the adjustment position of a first seat component is determined and the energy is absorbed by the energy absorption device on an adjusting device of a second seat component.

19. The method of claim 18, wherein the second seat component is a seat backrest of the motor vehicle seat, with the seat backrest being moved upright by the absorption of energy.
